(19) United States
(12) Patent Application Publication
(10) Pub. No.: US 2007/0240011 A1
(43) Pub. Date: Oct. 11, 2007

(54) FIFO memory data pipelining system and method for increasing I²C bus speed

(75) Inventors: Ramesh Saripalli, Tucson, AZ (US); Hugo Cheung, Tucson, AZ (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/398,121

(22) Filed: Apr. 5, 2006

(51) Int. Cl. G06F 1/00; G06F 13/42

(52) U.S. Cl. 713/500; 710/105

(57) ABSTRACT

An I²C system includes an I²C bus which includes an SCK (serial clock) conductor and an SDA (serial data) conductor, a master device coupled to the SCK conductor and the SDA conductor for sending and receiving data signals and serial clock signals. The master device includes a CPU, clock generation circuitry, and a control circuit that is coupled to the CPU, the SCK conductor, the SDA conductor, and the clock generation circuitry. A FIFO memory is coupled between the CPU and the control circuit. The CPU executes an address/data instruction, after sending a stop condition and then a start condition on the I²C bus, by causing an address byte and a plurality of data bytes to be written into the FIFO memory, causing the address byte to be read from the FIFO memory and transmitted on the I²C bus, causing a next data byte to be read from the FIFO memory and transmitted on the I²C bus, and repeating reading and transmitting of the data bytes until all of them have been transmitted on the I²C bus. A stop condition then is sent on the I²C bus.

### BACKGROUND OF THE INVENTION

The present invention relates generally to pipelining of start, stop, address byte and data byte transfer instructions in I²C logic systems.

Most known microcontrollers use the standard I²C bus as a peripheral bus that is used to communicate with other I²C devices, which typically are mounted on the same printed circuit board as the microcontrollers. The microcontrollers control the operation of the other I²C devices by configuring them and then writing/reading data to/from them via the I²C bus. Each start instruction, each address byte transfer, and each data transfer (i.e., each transaction) is associated with an interrupt to the CPU (central processing unit) of the microcontroller to indicate the status of the previous transmission. Based on the status of the prior data transmission or transaction, the CPU configures the I²C device for the next transaction.

For example, in an I²C master device in which the CPU wants to transfer 3 bytes, it would have to send a start condition on the I²C bus, then transfer the address byte and the three data bytes on the I²C bus, and then send a stop condition on the I²C bus. (The standard configurations of the I²C bus for a “stop condition” and a “start condition”, respectively, are well known to those skilled in the art.) Each of these five tasks would be followed by an interrupt to the CPU, so five interrupt routines would have to be executed by the CPU, one after the start condition, one after transmission of the address, and three and after transmission of the 3 data bytes, respectively. The execution of each interrupt adds “dead time”, typically a few milliseconds or more, between two successive microcontroller transactions in substantially reducing the overall I²C bus speed and therefore substantially diminishing the effective CPU processing power. In addition to increasing system response times, the need to handle more interrupts also necessitates use of more complicated program code, both for I²C master and slave modes for transmission and reception of data along the I²C bus.

For more background information to better understand the foregoing, note that Conventional I²C systems are described in detail in the publication “THE I²C-BUS SPECIFICATION, VERSION 2.1, JANUARY 2000”, which is incorporated herein by reference. I²C devices ordinarily have a CPU (although some “stand-alone” I²C devices, such as an ADC, may not include a CPU). I²C devices are usually implemented at a certain protocol level that may be dependent on their main intended use. An I²C device functioning in its slave mode is often referred to simply as a “slave”, and an I² device functioning in its master mode is often referred to simply as a “master”.

The closest prior art is believed to include the assignee's MSC 1211 product, relevant parts of which are shown in prior art FIGS. 1-4. It may be helpful to provide a description of the basic structure and operation of the prior art before proceeding to a description of the present invention. Referring to prior art FIG. 1, an I²C system includes a serial data bus conductor 2 which conducts the serial clock data signal SDA and a serial clock conductor 3 that conducts the serial clock signal SCK. The I²C system also includes an I²C slave device 5 and an I²C master device 10, both of which are connected to SCK conductor 3 and SDA conductor 2. The serial data bus conductor 2 and serial clock conductor 3 are collectively referred to as the “I²C bus”.

Master device 10 (which actually may be an I²C device that is set to operate in its master mode) includes clock generation circuitry 6, shown in detail in FIG. 3. Clock generation circuitry 6 is coupled to SCK conductor 3. Clock generation circuitry 6 is bidirectionally coupled by multiple conductors 53 to a control logic circuit 240, which includes a conventional finite state machine. Control logic circuit 240 produces an interrupt signal INT on conductor 52, which is connected to an interrupt input of a master CPU 110. Master CPU 110 receives control signals on multiple conductors 51 from control logic 240 and sends control signals on multiple conductors 50 to control logic circuit 240. Master device 10 also includes a transmit/receive shift register 220 which is bidirectionally coupled to SDA conductor 2. Transmit/receive shift register 220 is also bidirectionally coupled by multiple conductors to a read/write buffer 230, which is bidirectionally coupled by multiple conductors to control logic circuit 240.

Slave device 5 (which actually may be an I²C device that is set to operate in its slave mode) includes an N-channel transistor 17 having its drain connected to SCK conductor 3 and its source connected to a ground conductor. The gate of transistor 17 is connected to control logic circuit 24, which includes a finite state machine (FSM). Slave device 5 includes a transmit/receive shift register 22 connected to SDA conductor 2. Transmit/receive shift register 22 is bidirectionally coupled by multiple conductors to a read/write buffer 23, which is coupled by multiple conductors to control logic circuit 24. Control logic circuit 24 can produce an interrupt signal INT on conductor 27, which is connected to an interrupt input of slave CPU 11. Control logic circuit 24 also is bidirectionally coupled via multiple control conductors 26 to slave CPU 11.

By way of definition, the term “I²C hardware” is used herein to refer to all of the circuitry of an I²C device except its CPU. For example, in FIG. 1, I²C device 5 acts as a slave and includes a CPU 10 and “I²C hardware” including transmit/receive shift register 22, read/write buffer 23, and control logic 24. I²C device 10 acts as a master and includes a CPU 110 and I²C hardware including clock generation circuitry 6, transmit/receive shift register 220, read/write buffer 230, and control logic 240.

Also by way of definition, it is to be understood that each time the CPU of an I²C device “executes” an instruction of a user program, the CPU “sends” one or more control signals or “commands” to the I²C hardware of that I²C device, and the I²C hardware acts in response to such control signals or commands. Whenever the I²C hardware performs a function that results in a signal or signal “condition” being transmitted on the I²C bus 2,3, the signal or signal condition is said to be “sent to” or “sent on” the I²C bus. That is, an instruction of a user program is accessed and immediately “executed” by the CPU which then “sends” a corresponding control signal or command to the I²C hardware, which responds by “sending” a corresponding signal or “condition” on the I²C bus 2,3.

Usually, the above-defined I²C hardware provides feedback to the CPU (either by directly interrupting the CPU or by being polled by the CPU, both of which are very time-consuming) to let the CPU know the status of the I²C hardware so it can operate to control the I²C hardware and/or execute the next instruction.

It should be understood that the amount of time required for the I²C hardware to respond to the commands bears no relation to the amount of time required for the CPU to execute the instruction, because the time required for the CPU to execute the instruction depends on the rate at which the CPU is clocked but the time required for the I²C hardware to respond to the command could be much shorter or much longer than the amount of time required for the I²C hardware to respond to the commands.

FIG. 2 illustrates a typical sequence of events during operation of a conventional I²C system including a master and a slave to help in understanding basic I²C system operation. Both a master and a slave can function in a receive mode or a send mode. In every data time frame there are nine clock pulses, the first eight clock pulses of which are used by the master to send the data byte. During the ninth clock pulse a “0” is produced on SDA conductor 2 by the slave if an acknowledge signal ACK is to be sent by the slave, or alternatively, a “1” is produced on the SDA conductor by the slave if a “not acknowledge” signal or condition “NACK” (hereinafter referred to as a “not acknowledge signal NACK”) is sent by the slave to inform the master that the slave is not acknowledging that it received the data byte and is not accepting or reading the data byte being transmitted by the master on SDA conductor 2. (An example of the process of the slave reading a data byte includes the slave CPU 11 in FIG. 1 performing the step of reading R/W buffer 23.) Thus, if no slave is trying to pull SDA conductor 2 low (i.e., a NACK signal is being sent), SDA conductor 2 assumes a high value, i.e., a “1” level, but if SDA conductor 2 is low during the ninth clock pulse of the present data time frame, that means the slave is acknowledging that it has received the data byte sent on SDA conductor 2 by the master.

The user software determines in advance whether the slave is to send either an acknowledge signal ACK or a “not acknowledge” signal NACK on the SDA conductor during the ninth clock pulse of the present data time frame.

In FIG. 2, block 60 indicates whether the user program has determined whether or not the slave will respond by sending either a previously set up acknowledge signal ACK or “not acknowledge” signal NACK. After the data byte has been received by the slave, it will then “send” whichever of the ACK signal or NACK signal was previously set up in accordance with block 60. As indicated in block 30-1 of FIG. 2, the slave in a conventional I²C system receives a data byte transmitted by the master during the first eight SCK pulses of a 9-pulse data time-frame. Referring to block 31-1, the slave sends either an acknowledge signal ACK on SDA conductor 2 to let the master know that the slave has received the transmit data byte or a “not acknowledge” signal NACK to let the master know that the slave is not accepting or reading any data byte being sent by the master on SDA conductor 2.

Referring to block 32-1A in FIG. 2, after receiving the data byte and sending an acknowledge signal ACK, the I²C slave hardware does not know what its CPU will do next. For example, the slave may not yet have a next byte available to be sent to the master. What the slave can then do is to stretch clock SCK to indicate that the master must wait, and then the slave can interrupt the slave CPU and inform it that the slave has received the current byte and has sent an acknowledge signal ACK. To determine if the slave has received the data byte and to determine whether the slave can send an acknowledge signal, slave CPU 11 can either service an interrupt or perform a polling operation. If control logic 24 sends an interrupt signal INT to slave CPU 11, it reads the data byte that it has received, as indicated in block 32-1B. Once the data byte is read, slave CPU 11, at the beginning of block 32-1C, also sets up the slave as indicated in block 61 of FIG. 2 to send an acknowledge signal ACK or a “not acknowledge” signal or condition NACK after it receives the next data byte. Then, as indicated in block 32-1C, the slave “releases the stretch” of SCK.

Note that after the slave has received the first data byte, it does not always need to set up the acknowledge/“not acknowledge” decision again for each of the multiple successive data bytes to be received by the slave. For example, if the slave CPU wants the slave to receive 10 successive data bytes, the slave does not need to set up the acknowledge/“not acknowledge” decision again for each of the remaining 9 data bytes. The ACK/NACK bit (i.e., the ninth bit of each data time frame) remains set until it is cleared. The slave therefore will send an acknowledge signal ACK for each of the 10 data bytes without the acknowledge/“not acknowledge” bit being reset. After the stretch release referred to in block 32-1C of FIG. 2, the master then can send the next data byte on SDA conductor 2, and the process in the slave is repeated for the next data byte, as indicated in blocks 30-2 and 31-2.

As general background, it should be understood that the above described process is a “handshaking” process wherein the slave stretches clock signal SCK to inform the master to not send any more SCK pulses, and the slave control logic then sends an interrupt signal INT to its own slave CPU 11 and informs slave CPU 11 that a data byte has been received and the clock SCK has been stretched. Then the slave CPU 11 reads that data byte and sets up the appropriate conditions for the next event to happen (e.g., the slave CPU sets up the slave to send either an ACK signal or a NACK signal after the next data byte is received as indicated in block 61, after the present stretch of SCK has been released). Then, when the slave is ready it “releases the stretch” of SCK. The master then can continue control of clock signal SCK and data signal SDA.

A “back-to-back stop and start operation” in a conventional I²C system such as the above mentioned MSC 1211 includes executing a stop instruction followed, after a particular delay, by executing a separate start instruction. When master 10 communicates to slave 5, at the end of that communication master 10 sends a stop condition on I²C bus 2,3 before attempting to initiate communication with another slave by means of another start instruction. Master 10 executes a “combined” stop and start instruction wherein a stop instruction and a start instruction are pipelined. First, the pipelined stop instruction is executed. The control logic & finite state machine 87 (subsequently described with reference to FIG. 4) does not have to notify master CPU 110 that the stop condition has been sent to I²C bus 2,3 as is required in earlier I²C systems. Instead, control logic & finite state machine 87 automatically sends the start condition on I²C bus 2,3 after a predetermined delay. Then a start condition is automatically sent on I²C bus 2,3, in response to the pipelined start instruction. This avoids the separate programming and executing of stop and start instructions required by earlier I²C systems.

However, the logic circuitry of a prior art I²C system such as the MSC 1211 cannot simultaneously handle the combination of a start instruction, a stop instruction, and an address byte instruction and/or a data transfer instruction. The CPU must be notified by the I²C hardware that execution of the start instruction is complete before the CPU can execute the address byte transfer instruction. Also, the software executed by a CPU of an I²C device has to wait until the stop, start and address byte instructions have been executed and acted on by the I²C hardware and until the data byte transfer instruction is executed before the required signals are sent by the CPU to the I²C hardware. These requirements reduce the I²C bus speed and the data throughput rate of the I²C system.

The circuitry shown in FIG. 4 is included in the assignee's above mentioned MSC 1211 product for allowing master 10 to “pipeline” a stop instruction and a start instruction so the programmer can provide a stop instruction and the following start instruction at the same point of an application program to be executed by master 10 and thereby avoid the inconvenience of providing and executing the start instruction at a later point in the application program. Referring to FIG. 4, master 10 includes master CPU 110. A transmit buffer (Tx buffer) 76 is bidirectionally coupled by conductors 78 to master CPU 110. Transmit buffer 76 is coupled to a transmit shift register (Tx shift reg.) 77. Transmit shift register 77 is coupled by a conductor 80 to “control finite state machine 87”, hereinafter referred to simply as “finite state machine 87”.

Control logic 94 feeds back signals to finite state machine 87 via a bus 95 to enable it to make logical decisions according to the present circumstances. Data can be serially coupled from finite state machine 87 to conventional pad interface circuitry 79 by means of conductor 83. Clock generation circuit 6 of prior art FIG. 3 is included in control logic 94. Master CPU 110 is bidirectionally coupled by conductors 82 to start instruction circuitry 81, which is also bidirectionally coupled by conductors 84 to finite state machine 87. Master CPU 110 also is bidirectionally coupled by conductors 91 to stop instruction circuitry 85. Stop instruction circuitry 85 is bidirectionally coupled by conductors 88 to finite state machine 87.

A receive buffer circuit (Rx buffer) 89 is bidirectionally coupled by conductors 89A to master CPU 110, and also is coupled to a receive shift register (Rx shift register) 90. Receive shift register 90 is coupled by conductor 93 to finite state machine 87. Conductor 92 conducts serial data from pad interface circuitry 79 to finite state machine 87. Pad interface circuitry 79 is bidirectionally coupled to SDA conductor 2 and SCK conductor 3. Master CPU 110 is bidirectionally coupled by conductors 96 to control logic 94. Control logic 94 is bidirectionally coupled by various conductors 95 to finite state machine 87 and pad interface circuitry 79.

SDA conductor 2 and SCK conductor 3 are connected to corresponding integrated circuit bonding pads (not shown). Control signals are coupled to the pad interface circuitry 79 for each of the SCK and SDA bidirectional bonding pads, respectively, including internal enable signals on conductors 95 applied to control pad interface circuitry 79, which allow the bidirectional SDA conductor and the bidirectional SCK conductor to function both as serial inputs and serial outputs of master 10.

Above-mentioned stop instruction circuit 85 includes a stop instruction bit, which, when set by master CPU 110, causes a stop condition to be generated on I²C bus 2,3 at the appropriate time by master 10. Similarly, start instruction circuit 81 includes a start instruction bit, which, when set by master CPU 110, causes the following start condition to be generated later on I²C bus 2,3, after the appropriate delay time has been counted by tick counter 40. Master CPU 110 can set the start bit in block 81 while it is sending or receiving a data byte. Once the start bit is set, master CPU 110 waits to be informed that the current byte transaction is finished, and then executes the start instruction.

In response to a combined stop/start instruction, master CPU 110 can, in accordance with known I²C protocol, write into start instruction circuitry 81 and stop instruction circuitry 85, and also into transmit buffer 76 and receive buffer 89. A stop instruction must be executed first, and the execution of a start instruction must follow the execution of a stop instruction by a predetermined delay. Execution of the start instruction must be followed by other communication, i.e., transmission of an address byte and one or more data bytes. The logic circuitry in block 75 determines if master CPU 110 is writing “parallel” instructions such as a combined stop/start instruction, wherein finite state machine 87 checks the parallel instructions in accordance with the present situation and accordingly sends appropriate timing information to master CPU 110 at times allowed by the I²C protocol. Finite state machine 87 can send signals, such as interrupt signals, to control logic 94, from which master CPU 110 can obtain appropriate information regarding when to later cause an address byte to be transmitted on SDA conductor 2.

Specifically, a stop condition is generated first, followed by a counting of the time required before execution of the next start condition can begin. The start condition then is sent on I²C bus 2,3. The counting referred to is based on the microsecond tick counter circuit 40 in FIG. 3, which is coupled to finite state machine 87 as shown in FIG. 4. Tick counter 40 is loaded with the required amount of time to be counted from either block 35 or block 36 in FIG. 3, corresponding either to standard mode or fast mode I²C operation. The loaded times are then counted down by tick counter circuit 40 to determine the time intervals between the times at which instructions are set up and the times at which they are to be executed. After the required time interval is counted, the I²C hardware sends the start condition on I²C bus 2,3.

A known I²C protocol determines whether a byte is an address byte or a data byte, and finite state machine 87 always determines that an address byte is the first byte to be transmitted after a start condition has been sent on I²C bus 2,3, but has no other way of distinguishing between an address byte and the data byte. In the receive mode, if receive buffer 89 is empty after a data byte has been received by master 10 and loaded into receive shift register 90, the data byte is transferred to receive buffer 89, and master 10 can continue to receive a next data byte during to the next eight CLK pulses.

To understand how the transmit and receive shift registers operate, assume that master 10 wants to transmit a byte on SDA conductor 2. To accomplish this, master CPU 110 writes the byte to transmit buffer 76. Transmit buffer 76 checks to see if transmit shift register 77 is presently empty, and if it is empty, transmit buffer 76 sends the byte to transmit shift register 77. Transmit shift register 77 then signals finite state machine 87 to determine whether master 10 is in the correct mode to send a byte. If master 10 currently is in its receive mode, it is receiving data from a slave, in which case finite state machine 87 does not allow master 10 to receive data on SDA conductor 2. Finite state machine 87 waits for the data byte being received to be available to master CPU 110. When this has occurred, receive shift register 90 signals finite state machine 87, causing it to resume generation of SCK to allow master 10 to transmit the byte on SDA conductor 2.

As mentioned above, the prior art MSC 1211 has to wait until master CPU 110 has been interrupted and notified that the start condition has been sent on I²C bus 2,3 before CPU 110 can write the address byte into the transmit buffer 76. It is important to note that the MSC 1211 only combines a stop instruction and start instruction as a single instruction. However, the MSC 1211 can not combine or pipeline the start instruction and an address byte. The I²C hardware must inform master CPU 110, either by means of an interrupt operation or a polling operation, that the start condition has been sent on I²C bus 2,3 before beginning execution of an address byte instruction. Similarly, the I²C hardware must inform master CPU 110, either by means of an interrupt operation or a polling operation, that the sending of the address byte on the I²C bus is complete and that an acknowledge (ACK) or not acknowledge (NACK) message has been received from a receiving I²C slave device before beginning execution of a data byte transfer instruction. When master CPU 110 executes the start instruction, finite state machine 87 first checks to determine if I²C bus 2,3 is free (i.e., is not being used by any other master I²C device and that there is no other communication occurring on I²C bus 2,3). As soon as the I²C bus is free, finite state machine 87 sends the start condition onto the I²C bus, and then interrupts the master CPU to inform it when finite state machine 87 has completed that task. Master CPU 110 then services that interrupt by executing an instruction to write an address byte, via transmit buffer 76 and transmit shift register 77, to control finite state machine 87, which then shifts the address byte onto SDA conductor 2. Then finite state machine 87 interrupts master CPU 110 to notify it that the address byte has been sent on I²C bus 2,3, and then writes the data byte to finite state machine 87 via the same transmit buffer 76 and transmit shift register 77. Finite state machine 87 then transfers the data byte onto I²C bus 2,3, and then interrupts master CPU 110 to inform it that the data byte has now been transferred onto the I²C bus. Master CPU 110 then causes finite state machine 87 to send a stop condition on I²C bus 2,3.

It would be desirable to avoid the interrupt or polling operation and the delay required in prior art devices (such as the MSC 1211) prior to sending an address byte on the I²C bus. It also would be desirable to avoid the interrupt operation or polling operation and the delay required in prior art devices (such as the MSC 1211) prior to sending a data byte on the I²C bus.

### SUMMARY OF THE INVENTION

It is an object of the invention to provide an I²C device which can eliminate the “dead time” that occurs due to execution of interrupt routines required between transfers of data bytes in prior I²C systems.

It is another object of the invention to provide an I²C device which interrupts its CPU on the basis of “protocol boundaries” wherein the CPU is interrupted only after sending or receiving data, rather than on the basis of “byte boundaries”.

It is another object of the invention to provide an I²C device which requires execution of only a single interrupt routine for I²C system operation between a start condition and the next start condition.

It is another object of the invention to provide an I²C device which simplifies user software and reduces CPU processing overhead.

Briefly described, and in accordance with one embodiment, the present invention provides an I²C system including an I²C bus which includes a serial clock conductor (3) for conducting a serial clock signal SCK and a serial data conductor (2) for conducting a serial data signal SDA. The system includes a master device (1) coupled to the serial clock conductor (3) and the serial data conductor (2) for sending and receiving data signals on the serial data conductor (2) and generating the serial clock signal SCK on the serial clock conductor (3). The master device (1) includes a CPU (110), clock generation circuitry (6,101), and a control circuit (94) that is coupled to the CPU (110), the serial clock conductor (3), the serial data conductor (2), and the clock generation circuitry (6,101). A FIFO (First In, First Out) memory (86) is coupled between the CPU (110) and the control circuit (94). After a stop condition and then a start condition has been sent on the I²C bus, the CPU (110) executes a combined address/data instruction by causing the controller circuit (94) to write an address byte and a plurality of data bytes into the FIFO memory (86), read the address byte from the FIFO memory (86) and transmit it on the I²C bus and have been received an acknowledge signal. The CPU (110) and then reads a next data byte from the FIFO memory (86) and transmits it on the I²C bus, receives an acknowledge signal, and repeats until all of the plurality of data bytes have been transmitted on the I²C bus. A stop condition then is sent on the I²C bus.

In the described embodiment, a transmit/receive shift register (98) is coupled between the FIFO memory (86) and the control circuit (94), which includes a finite state machine. The address byte and the plurality of data bytes are written in parallel format into the FIFO memory (86). In the described embodiment, the FIFO memory (86) includes a direct memory access (DMA) controller (105) coupled to the control circuit (94) and a random access memory (108) coupled to the DMA controller (105). The DMA controller (105) is coupled to the control circuit (94) by means of the transmit/receive shift register (98).

In the described embodiment, a start instruction circuit (81) is coupled between the CPU (110) and the control circuit (94) and a stop instruction circuit (85) is coupled between the CPU (10) and the control circuit (94). The CPU (110) executes a combined stop/start/address/data instruction which includes the foregoing address/data instruction by setting or pipelining a stop bit in the stop instruction circuit (85), and setting or pipelining a start bit in the start instruction circuit (81). The control circuit (94) causes the stop condition to be automatically sent on the I²C bus (2,3) in response to the stop bit, the control circuit (94) causes the start condition to be automatically sent on the I²C bus (2,3) in response to the start bit a predetermined amount of time after the stop condition has been sent. The control circuit (94) causes the address byte and the plurality of data bytes to be automatically transferred from the FIFO memory (86) to the serial data conductor (2) a predetermined delay after the sending of the start condition.

The invention also provides a method for improving data speed in an I²C system including an I²C bus (2,3) that includes a serial clock conductor (3) for conducting a serial clock signal SCK and a serial data conductor (2) for conducting a serial data signal SDA, including providing a master device (1) coupled to the serial clock conductor (3) and the serial data conductor (2) for sending and receiving data signals on the serial data conductor (2) and generating the serial clock signal SCK on the serial clock conductor (3), wherein the master device (1) includes a CPU (110), clock generation circuitry (6,101), and a control circuit (94) coupled to the CPU (110), the serial clock conductor (3), the serial data conductor (2), and the clock generation circuitry (6,101). The CPU (110) is operated to execute an address/data instruction by storing an address byte and a plurality of data bytes in a FIFO (First In, First Out) memory (86). The control circuit (94) is operated to send a stop condition on the I²C bus (2,3). The control circuit (94) is operated to automatically send a start condition on the I²C bus (2,3) a predetermined amount of time after sending the stop condition, and the control circuit (94) also is operated in response to the address/data instruction to automatically transmit the address byte and the plurality of data bytes on the serial data conductor (2) after the start condition has been sent. The address byte and the plurality of data bytes are written into a random access memory (108) by means of a direct memory access (DMA) controller (105) coupled to the control circuit (94) and the random access memory (108). The data bytes are shifted between a parallel format in the DMA controller (105) and a serial format in the controller (94) by means of a transmit/receive shift register (98).

The invention provides a system for improving data speed in an I²C system including an I²C bus (2,3) that includes a serial clock conductor (3) for conducting a serial clock signal SCK and a serial data conductor (2) for conducting a serial data signal SDA, including a master device (1) coupled to the serial clock conductor (3) and the serial data conductor (2) for sending and receiving data signals on the serial data conductor (2) and generating the serial clock signal SCK on the serial clock conductor (3). The master device (1) includes a CPU (110), clock generation circuitry (6,101), and a control circuit (94) coupled to the CPU (110), the serial clock conductor (3), the serial data conductor (2), and the clock generation circuitry (6,101). The system includes a means for operating the CPU (110) to execute an address/data instruction by storing an address byte and a plurality of data bytes in a FIFO (First In, First Out) memory (86), and also includes a means for operating the control circuit (94) in response to the address/data instruction to automatically sequentially send the address byte and the plurality of data bytes on the serial data conductor (2) after the start condition has been sent. In one embodiment, the control circuit operating means includes means for executing a stop/start/address/data instruction which includes the foregoing address/data instruction by setting a stop bit in a stop instruction circuit (85), setting a start bit in a start instruction circuit (81), and storing an address byte and a plurality of data bytes in the FIFO (First In, First Out) memory (86).

### BRIEF DESCRIPTION OF THE DRAWINGS

FIG. 1 is a block diagram of a prior art I²C system.

FIG. 2 is a timing diagram useful in explaining basic operation of a conventional I²C system.

FIG. 3 is a block diagram of prior art circuitry for providing accurate control of delays between various edges of the serial clock SCK and the serial data SDA signals in the I²C system of FIG. 1 for both standard mode and fast mode operation of an I²C system.

FIG. 4 is a block diagram of the prior art, including pipeline circuitry associated with executing back-to-back stop and start instruction and a subsequent address byte instruction and data transfer instruction.

FIG. 5 is a simplified block diagram of an I²C microcontroller including a memory system for executing back-to-back stop, start, address byte and multiple data byte transfer instructions according to the present invention.

FIG. 6 is a more detailed block diagram of the microcontroller shown in FIG. 5.

FIG. 7 is a flow diagram illustrating the execution of multiple interrupt routines required in the operation of prior art I²C microcontrollers.

FIG. 8 is a flow diagram illustrating the operation of the I²C microcontroller of the present invention with execution of only a single interrupt routine.

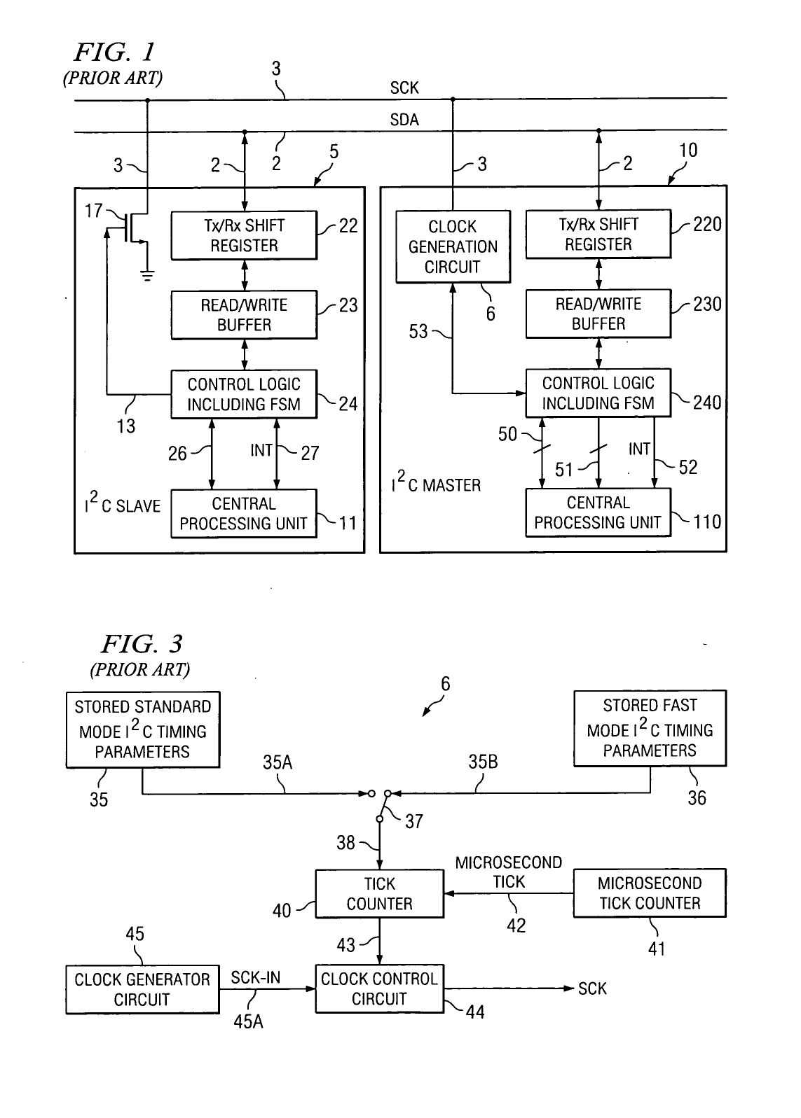

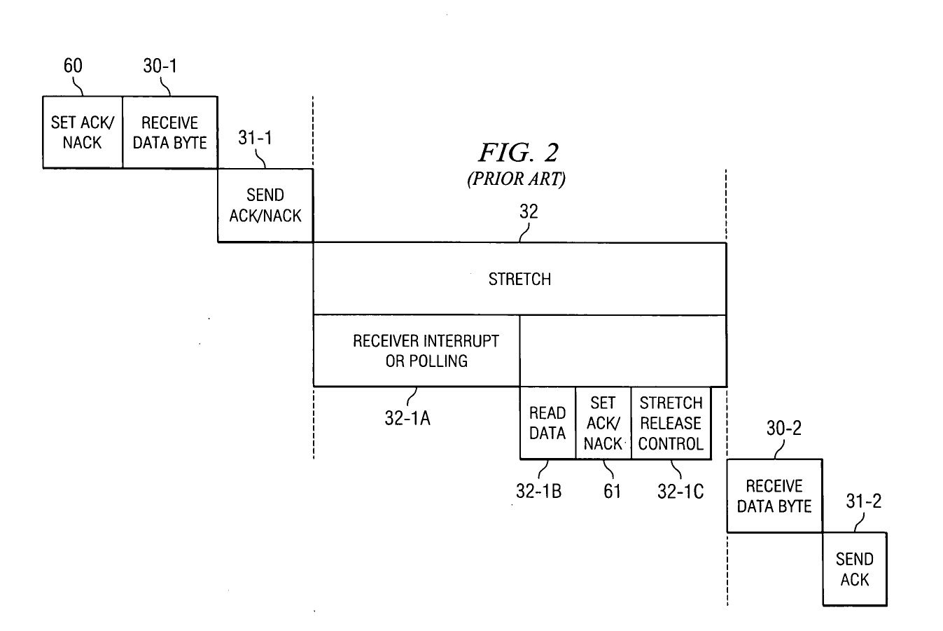

### DETAILED DESCRIPTION OF THE PREFERRED EMBODIMENTS

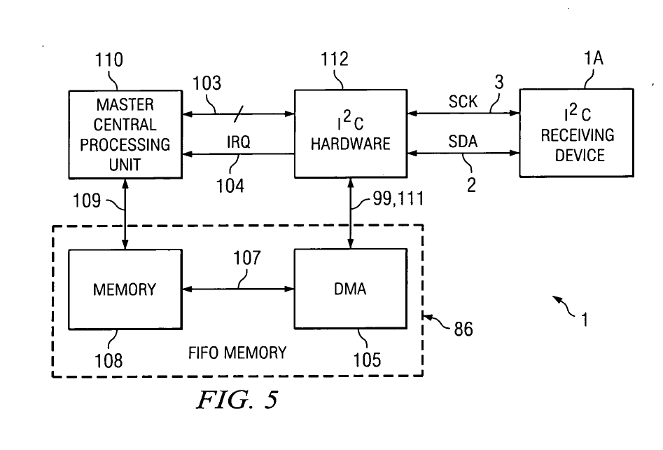

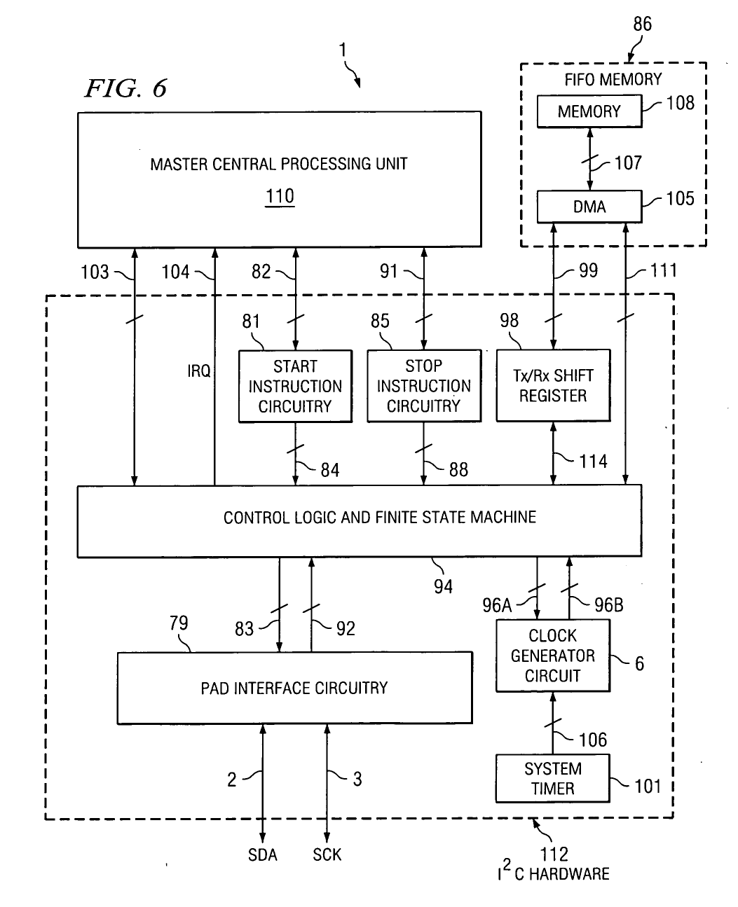

Referring to FIGS. 5 and 6, a microcontroller 1 includes a CPU 110 coupled by means of bidirectional bus conductors 103 to “I²C hardware” (as previously defined) 112, which is coupled to bidirectional SDA conductor 2 and bidirectional SCK conductor 3. A conductor 104 conducts interrupt requests IRQ from I²C hardware 112 to CPU 110. CPU 110 includes a FIFO (First In, First Out) memory 86. FIFO memory 86 can be implemented in various ways, for example as a conventional FIFO shift register or as a RAM (random access memory) 108 coupled by bidirectional bus 107 to a conventional DMA (direct memory access) controller 105, as illustrated. DMA controller 105 is coupled by a bidirectional bus 111,99 to I²C hardware 112. In FIG. 5, SCK conductor 3 and SDA conductor 2 are connected to one or more other I²C devices, such as a I²C receiving device 1A, which could be similar or identical to microcontroller 1 but set by the address byte transmitted by the master so as to cause it to be in its receive mode rather than its transmit mode.

Referring to FIG. 6, a more detailed diagram of I²C device 1 includes master CPU 110 bidirectionally coupled by conductors 82 to start instruction circuitry 81 which is bidirectionally coupled by conductors 84 to control logic & finite state machine 94. Master CPU 110 also is bidirectionally coupled by conductors 91 to stop instruction circuitry 85. Stop instruction circuitry 85 is bidirectionally coupled by conductors 88 to control logic & finite state machine 94, which is configured in accordance with conventional I²C protocol information. Master CPU 110 also is coupled to control logic & finite state machine 94 by conductor 104 and bidirectional conductors 103. Bidirectional conductors 103 are used for the purpose of writing to and reading from registers in I²C hardware 112 (i.e., registers in control logic & finite state machine 84 and Tx/Rx shift register 98 in FIG. 6), and conductor 104 is used for the purpose of sending interrupt requests IRQ to master CPU 110.

It should be appreciated that the structure of start instruction circuitry 81 and stop instruction circuitry 85 and their operation in pipelining a stop/start instruction are peripheral to the present invention and are not essential to the practice of the present invention.

In accordance with the present invention, Tx/Rx (transmit/receive) shift register 98 is bidirectionally coupled by conductors 114 to control logic & finite state machine 94 and by conductors 99 to FIFO memory 86. Specifically, DMA controller 105 of FIFO memory 86 is bidirectionally coupled by conductors 99 to Tx/Rx shift register 98, and is also bidirectionally coupled by conductors 111 to control logic & finite state machine 94. DMA controller 105 is bidirectionally coupled by conductors 107 to memory 108. In a write operation, CPU 110 writes data to control logic & finite state machine 94 of I²C hardware 112, which directs the data via conductors 111 to DMA controller 105, which in turn writes it into memory 108. To read data from memory 108, control logic & finite state machine 94 sends a request via conductors 111 to DMA controller 105, which reads the data from memory 108 and writes it into Tx/Rx shift register 98.

A clock generator circuit 6 is coupled to control logic & finite state machine 94 by multi-conductor buses 96A and 96B and also is coupled by conductors 106 to a system timer 101. Clock generator 6 includes known circuitry as shown in Prior Art FIG. 3. System timer 101 is a time base circuit which generates time base signals that are utilized by the microsecond tick counter 41 (FIG. 3) to enable it to generate various timing signals on conductors 96B for use by control logic & finite state machine 94 and to enable clock generator 6 to synchronously receive various control signals on conductors 96A from control logic & finite state machine 94. Microsecond tick counter 41 (FIG. 3) can be considered to be part of system timer 101. Bus 106 in FIG. 6 includes a number of conductors that may conduct various reference timing signals, including conductor 42 of FIG. 3, which conducts the signal MICROSECOND TICK.

Pad interface circuitry 79 is bidirectionally coupled to SDA conductor 2 and SCK conductor 3. A conductor of a multi-conductor bus 92 conducts serial data from pad interface circuitry 79 to control logic & finite state machine 94. A conductor of a multi-conductor bus 83 conducts serial data from control logic & finite state machine 94. Each of SCK conductor 3 and SDA conductor 2 is connected to a corresponding integrated circuit bonding pad (not shown) and also is connected to a corresponding conventional enabled buffer amplifier (not shown) which has an inverting buffer enable input, an input terminal IN (not shown) connected to control logic & finite state machine 94, and output terminal OUT (not shown) connected to the bonding pad. The output terminal OUT is connected by a switch to a pull-up resistor, the other terminal of which is connected to a power supply voltage. The output terminal OUT also is connected to conduct a signal to an input terminal of control logic & finite state machine 94. An output of control logic & finite state machine 94 is applied to the input terminal IN of the buffer amplifier, which is enabled by the buffer enable signal provided by control logic & finite state machine 94. The switch is controlled by a pull-up switch enable signal provided by control logic & finite state machine 94. The signal on the bonding pad is the signal produced by the buffer amplifier output terminal OUT if the buffer amplifier is enabled, or if an external signal is applied to the bonding pad, the signal on the bonding pad is applied to an input terminal of control logic & finite state machine 94.

It is to be understood that the term “instruction” herein refers to a programming code that is executed by master CPU 110, and a corresponding “condition” refers to a signal or group of signals produced on I²C bus 2,3 by various I²C hardware (previously defined) in response to the execution of the instruction. With the meaning of these terms in mind, it is to be understood that the described embodiment of the present invention provides a single combined “stop/start/address/multiple data byte” instruction which may be executed by master CPU 110 to first send a stop condition on I²C bus 2,3, and after a correct amount of separation time has elapsed between the stop condition and a start condition, control logic & finite state machine 94 then automatically sends the start condition on I²C bus 2,3, and then the address byte and multiple data bytes are sequentially sent on I²C bus 2,3. Another embodiment of the invention provides a single combined address/multiple data byte instruction which may be executed by master CPU 110 to cause the address byte and multiple data bytes to be sequentially sent on I²C bus 2,3 after a stop instruction and corresponding start instruction have been executed.

In accordance with the present invention, CPU 110 in FIG. 6 can write or pipeline an address byte and a desired number of corresponding data bytes into FIFO memory 86. This may be done (but is not necessarily done) at essentially the same time a stop bit of stop instruction circuitry 85 and a start bit of start instruction circuitry 81 are set, i.e. pipelined, by master CPU 110. At the beginning of the execution of a single combined “stop/start/address/multiple data byte” instruction of one embodiment of the present invention, master CPU 110 may, in effect, essentially simultaneously pipeline the stop instruction into stop instruction circuitry 85, the start instruction into start instruction circuitry 81, and an address byte along with any suitable desired number of corresponding data bytes into FIFO memory 86. Master CPU 110 then can continue executing other tasks while control logic & finite state machine 94 automatically sends the start condition on I²C bus 2,3 and also automatically causes the address byte and the corresponding data bytes to be transmitted via pad interface circuitry 79 onto SDA conductor 2. That is, the I²C hardware 112 detects that the start condition has been transmitted on I²C bus 2,3 and then operates so as to transmit the address byte and corresponding data bytes in serial format on I²C bus 2,3.

More specifically, the address byte and the desired number of corresponding data bytes are written by DMA controller 105 in parallel format into memory 108. Also, control logic & finite state machine 94 can causes the address byte and corresponding data bytes to be written by means of DMA controller 105 from memory 108 into Rx/Tx shift register 98 and then transferred in serial format from Tx/Rx shift register 98 and one of conductors 114 to control logic & finite state machine 94, which then automatically routes the address byte and corresponding data bytes in serial format to SDA conductor 2 via one of conductors 83 and pad interface circuitry 79. After the address byte and corresponding data bytes have been transmitted on I²C bus 2,3 by control logic & finite state machine 94, the receiving I²C slave device (e.g., I²C device 1A in FIG. 5) will send either an ACK signal or a NACK signal on I²C bus 2,3. Then control logic & finite state machine 94 interrupts master CPU 110 to inform it that the address byte and corresponding data bytes have been transmitted on I²C bus 2,3.

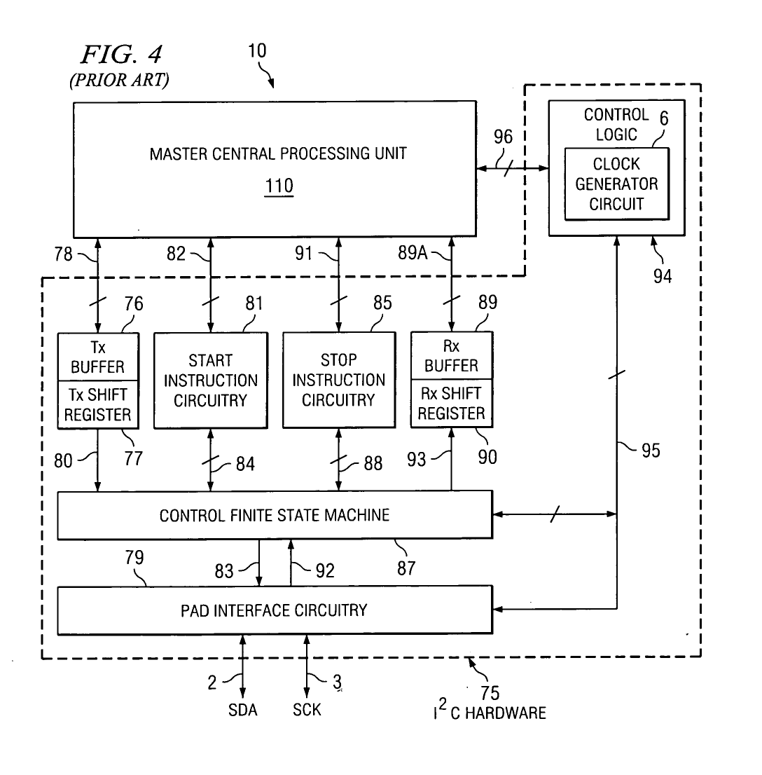

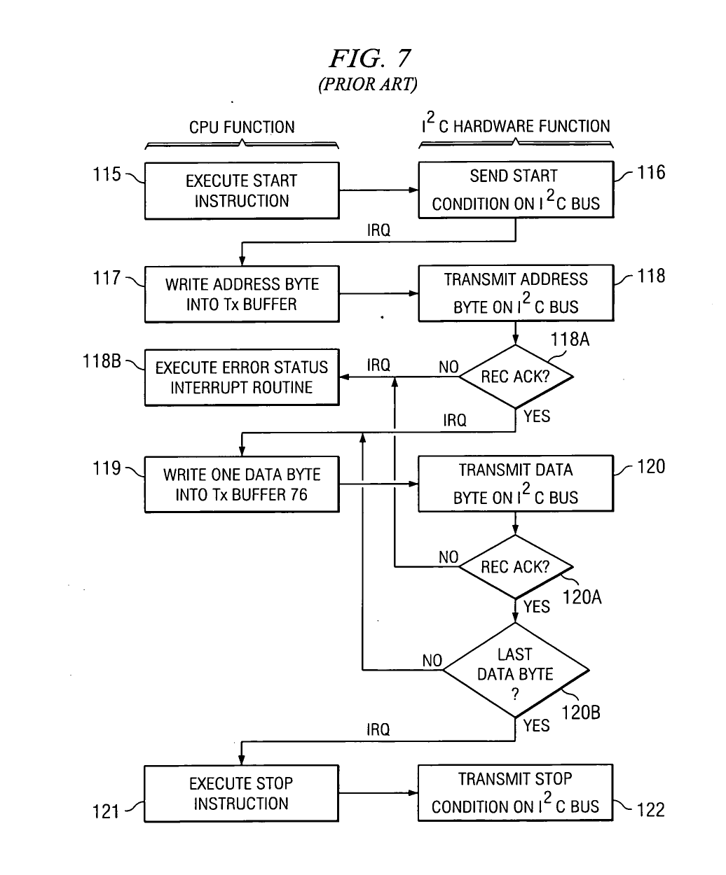

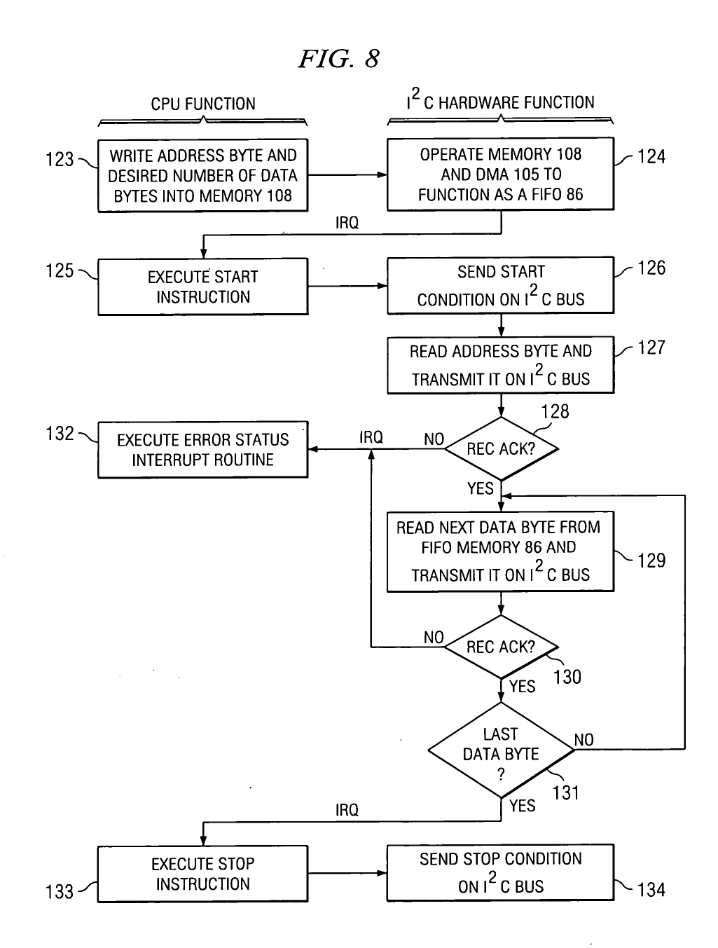

To facilitate understanding of the differences between the prior art of FIG. 4 and the present invention as shown in FIGS. 5 and 6, it may be helpful to compare the flow diagram of FIG. 7, which shows the operation of the prior art system of FIG. 4, with the flow diagram of FIG. 8, which shows the operation of the present invention as illustrated in FIGS. 5 and 6.

Referring to FIG. 7, CPU 110 of Prior Art FIG. 4 initiates a start instruction, as indicated in block 115. This causes the I²C hardware 75 of FIG. 4 to operate so as to send a start condition on the I²C bus 2,3 and then interrupt CPU 110, as indicated in block 116. CPU 110 responds to the interrupt request IRQ to write an address into Tx buffer 76, as indicated in block 117, and causes the I²C hardware 75 to transmit the address byte via Tx shift register 77 on the I²C bus, and, as indicated in decision block 118A, wait to receive an acknowledge signal ACK from an I²C receiving device. If the determination of decision block 118A is that no timely acknowledge signal ACK is received, then I²C hardware 75 sends an interrupt IRQ to CPU 110, causing it to execute an appropriate status interrupt routine as indicated in block 118B. If the determination of decision block 118A is affirmative, then I²C hardware 75 sends an appropriate interrupt request IRQ which causes CPU 110 to write one data byte into Tx buffer 76, as indicated in block 119.

CPU 110 then causes I²C hardware 75 to transmit the data byte on I²C bus 2,3 as indicated in block 120. Then, as indicated in decision block 120A, I²C hardware 75 waits to determine if a timely acknowledge signal ACK is received from the receiving I²C device. If not, I²C hardware 75 sends an interrupt request IRQ causing CPU 110 to execute the error status interrupt routine of block 118B. If the acknowledge signal ACK is timely received, then I²C hardware 75 determines if the previously transmitted data byte is the last data byte, as indicated in decision block 120B, and if it is not, CPU 110 writes the next data byte into Tx buffer 76 as indicated in block 119 and cause I²C hardware 75 to transmit the data byte on I²C bus 2,3 as indicated in block 120. After the last data byte has been transmitted on I²C bus 2, 3, I²C hardware 75 sends an appropriate interrupt request IRQ to CPU 110, causing it to execute a stop instruction routine, as indicated in block 121, to cause I²C hardware 75 to transmit a stop condition on I²C bus 2, 3, as indicated in block 122.

As mentioned above, every transaction performed by the prior art I²C hardware 75 is followed by an interrupt IRQ, requiring a time-consuming execution of a suitable interrupt routine by CPU 110.

Referring now to FIG. 8, in accordance with the present invention CPU 110 of FIGS. 5 and 6 initially, in response, for example to a combined “stop/start/address/data” (or combined “address/data”) instruction in the user program, writes an address byte and a desired number of corresponding data bytes in parallel format into memory 108 as indicated in block 123. CPU 110 then causes I²C hardware 112 to move the data into memory 108 by means of DMA 105 so that together they operate as a FIFO (first in, first out) register (e.g., FIFO memory 86 in FIG. 6), as indicated in block 124. I²C hardware 112 then sends an interrupt request IRQ to CPU 110, causing it to execute the start instruction, as indicated in block 125. As indicated in block 126, this causes I²C hardware 112 to operate so as to send a start condition on I²C bus 2,3 and then, as indicated in block 127, to read the address byte from FIFO memory 86 and then operate in the manner previously described so as to transmit the address byte in serial format on SDA conductor 2.

I²C hardware 112 then waits to receive an acknowledge signal ACK from the receiving I²C device (e.g., device 1A in FIG. 5), as indicated in decision block 128. If a timely acknowledge signal ACK is received and if there is a data byte in FIFO memory 86, I²C hardware 112 reads the next data byte from FIFO memory 86 and operates in the manner previously described so as to transmit the data byte in serial format on SDA conductor 2, as indicated in block 129. As indicated in decision block 130, if a timely acknowledge signal ACK signal is received from the receiving I²C device, I²C hardware 112 determines whether or not the previous data byte was the last one as indicated in decision block 131, and if not, the steps in the loop including blocks 129 and decision blocks 130 and 131 are repeated until all of the data bytes corresponding to the instruction have been sent on I²C bus 2,3. If the determination of decision block 131 is affirmative, I²C hardware 112 sends an appropriate interrupt request IRQ to CPU 110, and, as indicated in block 133, CPU 110 responds by executing the stop instruction, which as indicated in block 134, causes I²C hardware 112 to transmit a stop condition on the I²C bus.

As long as timely acknowledge signals ACK are received from the I²C receiving device after transmission of the address byte and each of the corresponding data bytes, that interrupt is the only one that occurs in response to the “stop/start/address/data” instruction. However if an appropriate acknowledge signal ACK is not received from the I²C receiving device as determined by either of decision blocks 128 and 131, then an error interrupt request IRQ is generated and causes CPU 110 to execute an appropriate error status interrupt routine as indicated in block 132.

Thus, when a start command is executed by CPU 110 of the microcontroller 1 in FIGS. 5 and 6, the corresponding pipelined address byte and corresponding data bytes will later be automatically transmitted on SDA conductor 2 without master CPU 110 first needing to be interrupted to be informed that the start condition has been sent on I²C bus 2,3 and without interrupting master CPU 110 after the address byte has been transmitted and also after each data byte has been transmitted. That is, control logic & finite state machine 94 needs to interrupt master CPU 110 only one time, i.e., after the address byte and desired number of data bytes have been transmitted via I²C bus 2,3 and the appropriate ACK signal has been received from the receiving I²C device to inform master CPU 110 that this has occurred. This is in contrast to the system of prior art FIGS. 4 and 7 wherein the address byte and the data byte are processed one at a time through the same transmit shift register 77 and wherein each of the foregoing transactions is performed in response to the master CPU being interrupted by the I²C hardware.

The foregoing procedure avoids the delay in the prior art MSC 1211 associated with interrupting master CPU 110 to notify it that the start condition has been sent on the I²C bus and avoids waiting for master CPU 110 to write the address byte into transmit buffer 76 and transferred it into transmit shift register 77. The need for software to cause master CPU 110 in FIG. 4 to service an interrupt and then write the address byte into transmit buffer 76 and into transmit shift register 77 is avoided.

When in its “master” mode, an I²C device sends a start condition, followed by the address byte, on the I²C bus. When in its “master transmit” mode, the I²C device transmits data after the address byte. When in its “master receive” mode, the I²C device receives data via the I²C bus after the address byte. Similarly to the above described case in which CPU 110 transmits an address byte and multiple corresponding data bytes on the I²C bus, a serial address byte followed by a desired number of corresponding serial data bytes can be received from SDA conductor 2, via pad interface circuitry 79, one of conductors 92, control logic & finite state machine 94, and one of conductors 114, and Tx/Rx shift register 98, and then the address byte and corresponding data bytes are transferred in parallel format via conductors 99 into FIFO memory 86. The address byte followed by the corresponding data bytes then are automatically read by master CPU 110.

As a hypothetical numerical example for comparing the speed advantage of the present invention with the prior art, consider the prior art I²C device of FIG. 4 running at a data rate of about 400 Khz and needing to transmit 3 bytes of data on the I²C bus. With the system clock at about 12 Mhz the lowest practical interrupt subroutine access time would be about 100 microseconds (which actually is a very conservative number which assumes a very efficient interrupt routine coding and also assumes that only I²C system operation subroutines are being accessed. Typical delays for sending the data would normally be 2 to 3 times or more greater than that). The amount of time required for sending the data of the kind under consideration would be about 10 microseconds (for the start instruction) plus 10 microseconds (for the stop instruction) plus 4*22.5 microseconds (for transmission of the address byte and 3 data bytes) plus 5*100 microseconds (for executing the 5 interrupt routines), that is, about 610 microseconds total. For the present invention, for example as shown in FIGS. 5 and 6, under the same conditions, the amount of time required for executing interrupt subroutines would be about 10 microseconds (for the start instruction) plus 10 microseconds (for the stop instruction) plus 4*22.5 microseconds (for transmission of the address byte and 3 data bytes) plus 100 microseconds (for executing the single interrupt routine), that is, about 210 microseconds. Thus, for this example the present invention reduces the amount of time required by nearly a factor of three. Furthermore, the effective data throughput rate increases even more as the number of data bytes to be transferred and received is increased.

Thus, the present invention provides a solution to the previously described problems of the prior art by providing an I²C device wherein an address byte and a desired number of corresponding data bytes are stored in FIFO memory 86 prior to being transmitted via the I²C bus 2,3. All of the data to be transmitted (or received) is written into the FIFO memory 86, then and the I²C hardware automatically transmits (receives) the address byte and all of the corresponding data bytes on the I²C bus and interrupts the master CPU 110 only once, i.e., when the transmission (reception) of all the data bytes is complete (or when there is a bus error). This reduces large amount of the dead time that otherwise is introduced by the many interrupts which occur between the data transfers in the prior art. The present invention also reduces the complexity of the firmware code associated with the numerous interrupt subroutines that the prior art requires to be executed between transfers of each data byte.

In addition to avoiding much of the software overhead and delay associated with the prior art procedure and hardware, the present invention provides the further advantage that the programmer is not restricted to providing the stop, start, address, and data instructions as individual instructions at particular separate points in the user program at times after which certain prior instructions and signal conditions have been completed.

The present invention can also be thought of as an I²C device which interrupts its CPU on the “protocol boundary”, whereas of the prior art I²C devices can be thought of as using “byte boundaries” to interrupt the CPU after the ends of address transfers and data transfers. That is, the I²C device interrupts its CPU on the basis of “protocol boundaries” wherein the CPU is interrupted only after sending or receiving a particular amount of data, rather than on every byte

While the invention has been described with reference to several particular embodiments thereof, those skilled in the art will be able to make various modifications to the described embodiments of the invention without departing from its true spirit and scope. It is intended that all elements or steps which are insubstantially different from those recited in the claims but perform substantially the same functions, respectively, in substantially the same way to achieve the same result as what is claimed are within the scope of the invention.

What is claimed is:

1. An I²C system for improving the data speed on an I²C bus which includes a serial clock conductor for conducting a serial clock signal SCK and a serial data conductor for conducting a serial data signal SDA, the system comprising:
(a) a master device coupled to the serial clock conductor and the serial data conductor for sending and receiving data signals on the serial data conductor and generating the serial clock signal SCK on the serial clock conductor, the master device including a CPU, clock generation circuitry, and a control circuit that is coupled to the CPU, the serial clock conductor, the serial data conductor, and the clock generation circuitry;
(b) a FIFO (First In, First Out) memory coupled between the CPU and the control circuit;
(c) the CPU executing a combined address/data instruction, after sending a stop condition and then a start condition on the I²C bus, by
i. writing an address byte and a plurality of data bytes into the FIFO memory,
ii. reading the address byte from the FIFO memory, transmitting it on the I²C bus, and receiving an associated acknowledge signal,
iii. reading a next data byte from the FIFO memory after receiving an acknowledge signal, transmitting that data byte on the I²C bus, and receiving another associated acknowledge signal,
iv. repeating the reading and transmitting of data bytes until all of the plurality of data bytes have been transmitted on the I²C bus; and
(d) the CPU then sending a stop condition on the I²C bus.

2. The system of claim 1 including a transmit/receive shift register coupled between the FIFO memory and the control circuit.

3. The system of claim 1 wherein the control circuit includes a finite state machine.

4. The system of claim 1 wherein the CPU writes the address byte and the plurality of data bytes in parallel format into the FIFO memory.

5. The system of claim 4 wherein the FIFO memory includes a direct memory access (DMA) controller coupled to the control circuit and a random access memory coupled to the DMA controller.

6. The system of claim 5 wherein the DMA controller is coupled to the controller by means of a transmit/receive shift register.

7. The system of claim 1 including an interface circuit coupling the control circuit to the serial clock conductor and the serial data conductor, wherein the start condition is automatically sent on the I²C bus via the interface circuit and the address byte and the plurality of data bytes are automatically transmitted on the I²C bus via the interface circuit.

8. The system of claim 7 including a start instruction circuit coupled between the CPU and the control circuit and a stop instruction circuit coupled between the CPU and the control circuit for pipelining stop/start instruction information.

9. The system of claim 8 wherein the CPU executes a combined stop/start/address/data instruction which includes the address/data instruction information by setting a stop bit in the stop instruction circuit, and setting a start bit in the start instruction circuit.

10. The system of claim 9 wherein the control circuit causes the stop condition to be automatically sent on the I²C bus in response to the stop bit, the control circuit causes the start condition to be automatically sent on the I²C bus in response to the start bit a predetermined amount of time after the stop condition has been sent, the control circuit causes the address byte and the plurality of data bytes to be automatically transferred from the FIFO memory to the serial data conductor a predetermined delay after the sending of the start condition.

11. The system of claim 7 wherein the clock generation circuitry is coupled to the control circuit and operates to determine intervals between times at which pipelined instructions are set up and times at which conditions corresponding to the pipelined instructions, respectively, are sent on the I²C bus.

12. The system of claim 11 wherein the clock generation circuitry determines a first interval between a time at which the stop condition is sent on the I²C bus and a time at which the start condition is sent on the I²C bus, and the control circuit operates in response to the pipelined start bit and the clock generation circuitry to cause the start condition to be automatically sent on the I²C bus after the first interval has elapsed.

13. The system of claim 12 wherein the clock generation circuitry determines a second interval between the time at which the start condition is sent on the I²C bus and a time at which the address byte is sent on the I²C bus, and the control circuit operates in response to the clock generation circuitry to cause the address byte and the plurality of data bytes to be automatically transmitted on the serial data conductor after the second interval has elapsed.

14. A method for improving data speed in an I²C system including an I²C bus that includes a serial clock conductor for conducting a serial clock signal and a serial data conductor for conducting a serial data signal, the method comprising:
(a) providing a master device coupled to the serial clock conductor and the serial data conductor for sending and receiving the data signal on the serial data conductor and generating the serial clock signal on the serial clock conductor, the master device including a CPU, clock generation circuitry, and a control circuit coupled to the CPU, the serial clock conductor, the serial data conductor, and the clock generation circuitry;
(b) operating the CPU to execute an address/data instruction by storing an address byte and a plurality of data bytes in a FIFO (First In, First Out) memory;
(c) operating the control circuit to send a stop condition on the I²C bus;
(d) operating the control circuit to automatically send a start condition on the I²C bus a predetermined amount of time after sending the stop condition; and
(e) operating the control circuit in response to the address/data instruction to automatically transmit the address byte and the plurality of data bytes on the serial data conductor after the start condition has been sent.

15. The method of claim 14 including writing the address byte and the plurality of data bytes in a random access memory by means of a direct memory access (DMA) controller coupled to the control circuit and the random access memory.

16. The method of claim 15 including shifting the data bytes between parallel format in the DMA controller and serial format in the controller by means of a transmit/receive shift register.

17. The method of claim 14 including operating the CPU to execute a combined stop/start/address/data instruction by pipelining a stop instruction and a start instruction before executing stop and start instructions, sending of an address byte, and sending/receiving data.

18. The method of claim 17 including pipelining the stop and start portions of the stop/start/address/data instruction by setting a stop bit in a stop instruction circuit and setting a start bit in a start instruction circuit.

19. A system for improving data speed in an I²C system including an I²C bus that includes a serial clock conductor for conducting a serial clock signal and a serial data conductor for conducting a serial data signal, the system comprising:
(a) a master device coupled to the serial clock conductor and the serial data conductor for sending and receiving the data signal on the serial data conductor and generating the serial clock signal on the serial clock conductor, the master device including clock generation circuitry, and a control circuit coupled to the serial clock conductor, the serial data conductor, and the clock generation circuitry;
(b) CPU means for executing an address/data instruction after a start condition has been sent on the I²C bus to store an address byte and a plurality of data bytes in a FIFO (First In, First Out) memory; and
(c) CPU means for operating the control circuit in response to the execution of the address/data instruction to automatically sequentially send the address byte and the plurality of data bytes on the serial data conductor.

20. The system of claim 19 wherein the CPU means executes a stop/start/address/data instruction that includes the address/data instruction by setting a stop bit in a stop instruction circuit, setting a start bit in a start instruction circuit, and storing an address byte and a plurality of data bytes in the FIFO (First In, First Out) memory.
